(19) United States
(12) Patent Application Publication
(10) Pub. No.: US 2014/0351485 A1
(43) Pub. Date: Nov. 27, 2014

(54) Differential File System for Computer Memory

(71) Applicant: Spansion LLC, Sunnyvale, CA (US)

(72) Inventors: Shulan DENG, San Jose, CA (US); Stephan Rosner, Campbell, CA (US); Venkataraman Natarajan, Sunnyvale, CA (US)

(73) Assignee: Spansion LLC, Sunnyvale, CA (US)

(21) Appl. No.: 13/901,167

(22) Filed: May 23, 2013

(51) Int. Cl. G06F 12/02; G06F 12/10

(52) U.S. Cl. CPC G06F 12/0246; G06F 12/1036
USPC 711/103; 711/209

(57) ABSTRACT

An approach is described to overcome the rapid consumption of available flash space when frequently modifying files stored on the flash space. This “differential” sector approach determines the correlation between the new content and the old content, and saves only the “delta” part of the old and the new content to the sectorized memory device. A predetermined threshold can be used to determine whether to use the “differential” sector approach or the fixed sector approach, based on the amount of data change in a given memory access request.

### BACKGROUND

1. Field

This invention relates generally to computer memory devices, and more particularly to systems and methods for improved utilization of computer memory devices.

2. Background Art

The electronics market has been undergoing extensive growth for decades. This trend is expected to continue for the foreseeable future since consumer products demand more and more electronic-based features. Most electronic features rely on semiconductor memory, and market forces demand that the semiconductor memory density increase while the costs decrease at the same time.

Crucial to the fulfillment of these market demands is the development of non-volatile (e.g., flash) memory that can be rewritten and can retain content without the consumption of power. Flash memory has become popular, at least in part, because it combines the advantages of high density and low cost of EPROM (erasable programmable read only memory) with the electrical erasure abilities of EEPROM (electrically erasable programmable read only memory).

Flash memory is nonvolatile, and therefore it can hold its content without on-going power. The physical structure of flash memory is particularly robust against physical forces such as shock, and is thereby eminently suitable for use in portable devices. Thus, flash memory can be used in many portable electronic products, such as cell phones, portable computers, voice recorders, thumb drives and the like, as well as in many larger electronic systems, such as cars, planes, industrial control systems, and similar applications. The fact that flash memory devices can be rewritten, retain data without a power source, have a small size and a light weight, have all combined to make flash memory devices a very attractive means for transporting and storing data.

Flash memory devices typically are less expensive and denser as compared to many other memory devices, and therefore flash memory devices can store more data per unit area. However, unlike dynamic random access memory (DRAM) devices and static random memory (SRAM) devices in which a single byte can be erased, flash memory devices are typically erased in fixed multi-bit blocks or fixed sectors, irrespective of whether or not only a small number of bytes require change.

### BRIEF SUMMARY

In response to the above shortcomings, there is a need to improve the write performance of memory devices, such as but not limited to the write performance of fixed sector devices such as flash memory devices. The approach described herein improves the efficiency of the write procedure and thereby extends the useful life of flash memory devices. The approach may be applied to any sectorized memory devices such as flash memory devices, and including both NOR and NAND flash memory devices. It is noted the invention is not limited to these example embodiments, but instead is applicable to any memory devices.

In an embodiment, an approach is described that includes receiving a memory write request for a memory sector in a memory device. The approach includes determining data differences by comparing the data content of the memory write request with existing content in one or existing memory sectors to determine content differences based on the comparison. Based on the data differences, a differential sector is written.

In another embodiment, following the determination of the content differences (as described above), the amount of data content differences is compared to a predetermined threshold. If the amount of content differences is less than the predetermined threshold, an existing memory sector is tagged as an updated sector, and a differential sector is written based on the data differences. However, if the amount of data differences is not less than the predetermined threshold, the existing memory sector is marked as a deleted sector, and a new sector is written based on the fixed-sector approach.

In a still further embodiment, a read approach is described that reads the relevant sectors to establish the existing data stored. A determination is made whether any of the relevant sectors are updated sectors. If the determination indicates that there is an updated sector, then the associated differential sector is read in order to construct the existing data content. If the sector is not tagged as an updated sector, then no further action is required beyond the read of the sector in the normal manner.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates a flash file system 100 in an operating environment, in accordance with an embodiment.

FIG. 2 illustrates the storage of data in a memory device using the fixed-sector approach, in accordance with an embodiment.

FIG. 3 illustrates the storage of “updated” or modified data in a memory device using the fixed-sector approach, in accordance with an embodiment.

FIG. 4 illustrates a data update approach in a memory device, in accordance with an embodiment of the present invention.

FIG. 5 illustrates a second data update scenario in a flash memory device, using the fixed-sector approach to flash file memory allocation, in accordance with an embodiment.

FIG. 6 illustrates the storage of “updated” data for the second data update scenario in a memory device using the fixed-sector approach, in accordance with an embodiment.

FIG. 7 illustrates the second data update scenario, using a differential-sector approach, in accordance with an embodiment of the present invention.

FIGS. 8A, 8B and 8C further illustrate the data update scenarios using both a fixed-sector approach and a differential-sector approach, in accordance with an embodiment of the present invention.

FIG. 9 provides a flowchart of a method that uses the differential-sector approach for a sectorized memory device, according to an embodiment of the present invention.

FIG. 10 provides a flowchart of a method that reads a sectorized memory device using the differential-sector approach, according to an embodiment of the present invention.

FIG. 11 illustrates the results of a simulation study that demonstrates the impact of the value of the predetermined threshold used in the differential-sector approach, according to an embodiment of the present invention.

FIG. 12 illustrates a memory device and an associated memory control circuit, in accordance with an embodiment of the present invention.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described. It is noted that embodiments are described herein with reference to flash memory for illustrative purposes; however, the invention is not limited to these examples, and embodiments of the invention are applicable to any type of memory devices.

Flash memory can come in at least two architectures, namely NOR flash and NAND flash. The advantages of NOR flash over NAND flash are random access ability, high read speed, and high reliability. The disadvantages of NOR flash are low density, slow write speed and slow erase speed. To store files in flash memory, a flash file system (FFS) is deployed in most embedded systems. However, a commonly recognized issue is that frequent modifications of files stored on NOR flash will quickly consume the available flash space due to the fact that data on the flash cannot be overridden directly. Prior to reuse, NOR flash must be erased and such erasures are performed in minimum units of one block (or one sector). Thus, frequent modifications (even relatively minor modifications) result in large sections of unusable flash space until sector-by-sector erasures are carried on the affected portions of flash space.

To illustrate this issue further, and without loss of generality, a flash file system (FFS) under a Linux operating system is used to demonstrate the issue, as well as various embodiments of the proposed new approach. It should be noted that the use of a Linux operating system is illustrative only, and does not limit the scope of various embodiments of the new approach. Thus, for example, embodiments of the present invention can be utilized in other operations systems, such as Windows, Unix, etc.

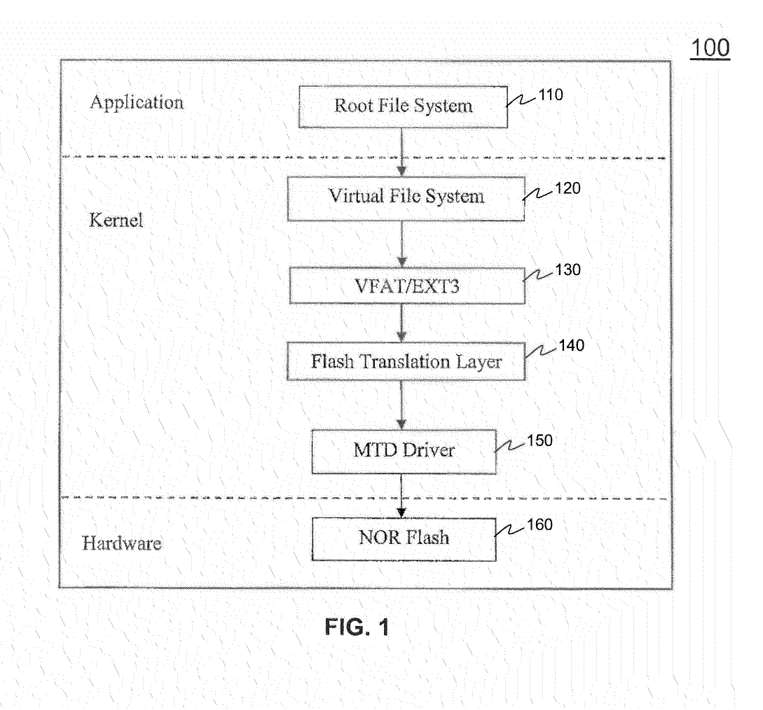

FIG. 1 illustrates a flash file system 100 in a Linux operating environment, in accordance with an embodiment of the present invention. In this particular embodiment, flash file system 100 supports NOR flash memory device 160. The use of NOR flash memory device 160 is purely illustrative, and not limiting, of memory devices to which embodiments of the present invention apply. In this example, the application that seeks to access NOR flash memory device 160 maintains a root file system 110 in which data is stored and retrieved locally, as required. Should the application wish to request data from NOR flash memory device 160, a request is forwarded to the Linux kernel (operating system), which maintains a virtual file system 120 that corresponds to root file system 110. The data request is then forwarded to virtual file access table (VFAT) 130, which is the file system maintained by the operating system (Linux kernel in this example). Next, the data request is forwarded to flash translation layer (FTL) 140, which in turn requests the data via a memory technology device (MTD) driver 150. The functionality of flash translation layer (FTL) 140 and memory technology device (MTD) driver 150 may be implemented using a memory control circuit, which takes external data access inputs and translates them to the requirements of a sectorized memory device, such as NOR flash memory device 160. Memory technology device (MTD) driver 150 communicates the data request with NOR flash memory device 160. In flash file system 100, NOR flash memory device 160 is treated as a fixed-sector (block) device, i.e., it is divided into logical blocks (also known as sectors) of a fixed number of bytes, such as 512 bytes. Flash memory devices, such as NOR flash memory device 160, are typically limited in their data access operations to block-oriented (fixed-sector) operations. Fixed sector operations include write sector, read sector, erase sector, and the like. Thus, in this example, flash file system 100 uses flash translation layer (FTL) 140 to translate read/write data requests into a request for fixed-sector read/erase/write in the NOR flash memory device 160. To further illustrate this Lon-limiting example, a write application programming interface (API) of flash translation layer (FTL) 140 may be as shown below:

FTL_Write(data, sector_num, num_sectors), where

“data” contains the data to be written to NOR flash memory device 160,

“sector_num” is a logical sequential number to the beginning flash sector to write, and “num_sectors” is the number of sectors to write.

When flash file system 100 opens an existing file for modification, the new content needs to replace the old content in the memory device, e.g., the old content stored in NOR flash memory device 160. However, for certain memory devices (e.g., NAND flash memory devices and NOR flash memory devices), the new content cannot be directly written to the flash memory device. Instead, a fixed-sector approach is used since sectorized memory device access operations must be performed on a sector-by-sector basis. In other words, the smallest memory structure that can be operated upon is a sector. Sub-sector operations are therefore not possible in the fixed-sector approach. Accordingly, in the fixed-sector approach, the physical sector storing the old content will be marked as a “deleted” sector, and the new content will be written to a different “free” physical sector. A “free” physical sector is a sector that is able to accept new data, and not currently used for purposes of storing content. In memory devices such as flash memory devices, if the “free” physical sector had previously been used for purposes of storing content, then the sector must be erased prior its designation as a “free” physical sector capable of storage of new content.

The fixed-sector approach in memory devices such as flash memory devices ensures that data is reliably stored, and that sectors can be re-used to accommodate later storage of new content. However, the fixed-sector approach may be inefficient. In fact, the fixed-sector approach is particularly inefficient when the sector content that needs to be updated is almost identical to the pre-update content (e.g., only a single byte of data needs to be updated). The fixed-sector approach is inefficient since even a one-byte change in the existing sector content of only a single byte results in the need for an entirely new sector to store the “updated” content.

Embodiments of the differential approach described in this disclosure address the numerous situations when “updated” content involves a relatively small amount of content change in one or more sectors. The approach described herein distinguishes between the pre-updated data content and updated data in a particular sector. In the new approach, the “delta” data portion (i.e., the particular portion of data that changes and requires updating) is saved to the memory device, rather than the entire updated data. To accomplish this, a differential algorithm has been developed that compares the “updated” data content with the pre-updated or “old” data content of a particular sector, and generates the “delta” data portion.

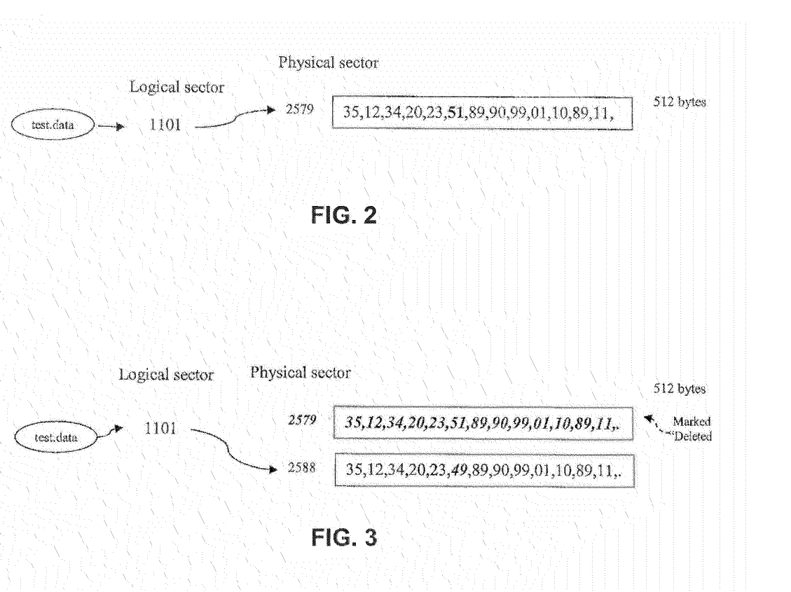

FIG. 2 illustrates the storage of data in a memory device using the fixed-sector approach. Referring to FIG. 2, the file test.dat is allocated one (1) sector space, i.e., logical sector 1101 in the flash memory device (e.g., NOR flash device 160) by flash file system 100. The logical sector number is mapped into a physical sector, in this example, physical sector 2579 by flash translation layer 140. Even though the actual file size of file test.dat can be less than 512 bytes, flash file system 100 always writes an entire sector (512 bytes in this example) to the flash memory device 160.

FIG. 3 illustrates the storage of “updated” or modified data in a memory device using the fixed-sector approach. Referring to FIG. 3, the file test.dat is forwarded to flash file system 100 for modification. The updated file test.dat requires the replacement of the value “51” of one byte (the 6th byte) with the updated value “49.” However, in the fixed-sector approach illustrated in FIG. 3, the data modification will not proceed by updating the particular byte involved in the flash memory device 160. Instead, to accomplish the data change in the flash memory device, flash file system 100 will mark physical sector 2579 as “deleted,” while a new “free” physical sector 2588 is allocated and stores the updated data. Thus, as shown in FIG. 3, the entire 512-byte content is written to the flash memory device 160, despite only one (1) byte being changed.

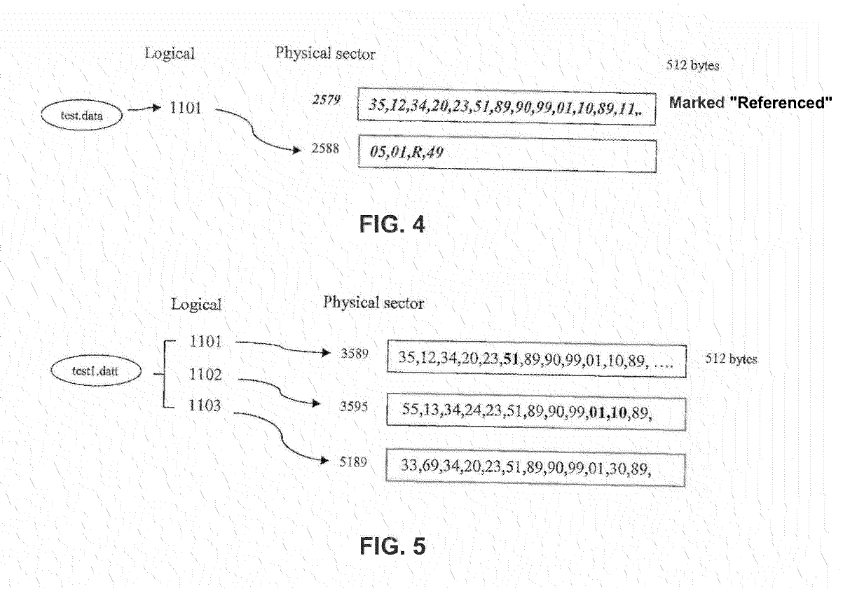

FIG. 4 illustrates a data update approach in a memory device, in accordance with an embodiment of the present invention. Referring to FIG. 4, an embodiment of the present invention uses a differential-sector approach to store the updated data. In the differential-sector approach, physical sector 2579 is marked as “referenced,” while a new physical sector 2588 (a “differential” sector) is used to store the updated value of “49.” In this example, a total of four (4) bytes are used to store the updated value. In this exemplary embodiment, the four (4) bytes used include the following descriptors. The first byte, having a value of “05,” indicates that the memory update begins at the sixth (6th) byte of the “old” or “referenced” sector. The second byte indicates that one (1) byte is altered in the old sector, and the third byte (having a value “R”) indicates that the memory operation is a “replacement” operation. The final byte indicates that the replacement value is “49.” Thus, the combination of the “referenced” sector 2579 together with the four (4) “differential” bytes in sector 2588 enables an economical storage of the updated data.

In addition to the storage information shown, a mapping table or equivalent is required to store the associations between the “referenced” sector and the “differential” sector. In situations where the current sector is already a “referenced” sector, the current value of data would be determined by reading the combination of the associated “referenced” and “differential” sectors. The “delta” is determined by a comparison of the updated data with the current data determined from the combined reading of the associated “referenced” and “differential” sectors. The “delta” is stored in a new “differential” sector, and the old “differential” sector is then marked as “deleted.”

As can be readily ascertained, the memory savings of the differential-sector approach are substantial. In the example illustrated in FIG. 4, rather than using a new sector containing 512 bytes, the file modification process can be accomplished using only four (4) bytes. The four (4) “differential” bytes provide the value(s) of the updated data, together with the descriptors that capture the “delta” between the original data and the updated data. Persons of ordinary skill in the art would recognize that the sequence and organization of the descriptors of information are exemplary and not limiting in terms of scope of the present invention. For example, in other embodiments, the sequence and organization of the descriptors in the differential-sector approach may be reordered or reorganized, while continuing to provide a sufficient description of the “delta” or change in data storage between an “old” and an “updated” sector.

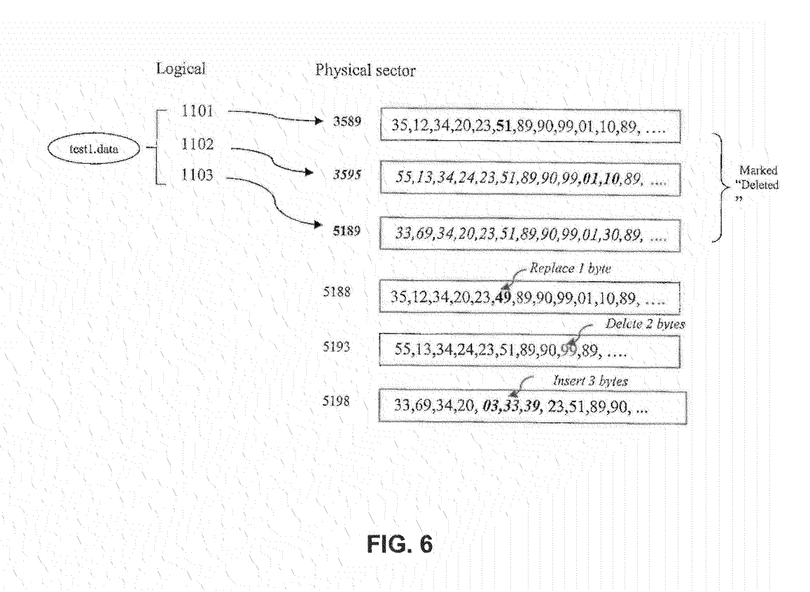

FIG. 5 illustrates a second data update scenario in a flash memory device 160, using the fixed-sector approach to flash file memory allocation. Referring to FIG. 5, the test1.dat file is stored by flash file system using three (3) sectors of flash space, from logical sector 1101 to 1103, which are in turn mapped to physical sectors 3589, 3595 and 5189, respectively. Next, the file test1.data is updated and the following changes are made: (a) replace value “51” in physical sector 3589 with “49”; (b) delete values “01” and “10” located at the 10th and 11th bytes in physical sector 3595; and (c) insert three bytes having values “03, 33, 39” at the 5th byte in physical sector 5189. To save these updates to the flash memory device 160, flash file system first marks physical sectors 3589, 3595, and 5189 as “deleted”. Next, three new sectors 5188, 5193 and 5198 are assigned to store the updated file test1.data using the fixed-sector approach, as illustrated in FIG. 6.

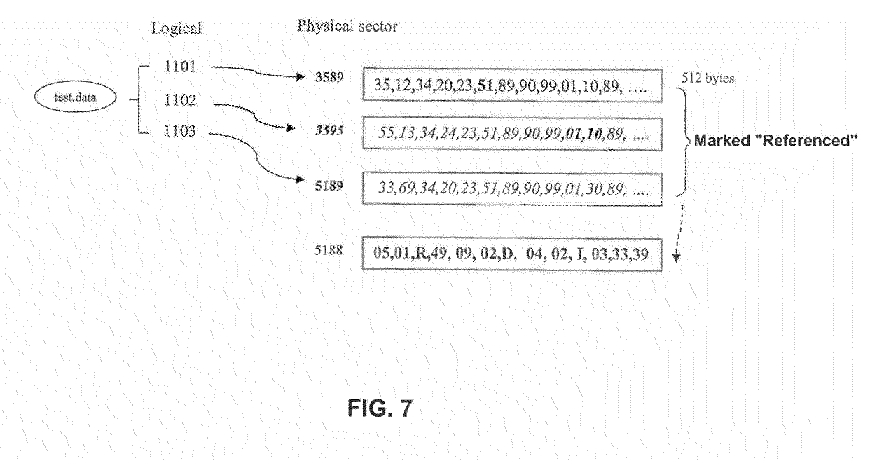

FIG. 7 illustrates the same data update scenario, but now using the differential-sector approach, in accordance with an embodiment of the present invention. First, physical sectors 3589, 3595, 5189 are marked as “referenced,” and now one (1) new sector (sector 5188) is allocated. In effecting this data update scenario, the differential-sector approach uses only 13 bytes of storage. As in the earlier embodiment, the set of descriptors “05, 01, R, 49” represents the update of a single byte, specifically the 6th byte of the sector, is replaced with the value “49”. The next set of descriptors “09, 02, D” indicates that two (2) bytes beginning with the 10th byte are deleted. Finally, the set of descriptors “04, 03, I, 03, 33, 39” denotes that three (3) bytes of data are inserted beginning at the 5th byte of the sector, with the inserted values being “03,” “33” and “39.”

As the two above scenarios in FIGS. 4 and 7 illustrate, the differential-sector approach provides substantial improvements, both in reduced flash space as well as in increased write speed when updating content in a file stored on a sectorized memory device such as a flash memory device. In the first scenario, write speed is increased (4 bytes written versus 512 bytes written). In the second scenario, flash space is reduced (1 sector versus 3 sectors) as well as in increased write speed (13 bytes written versus 512*3 bytes written).

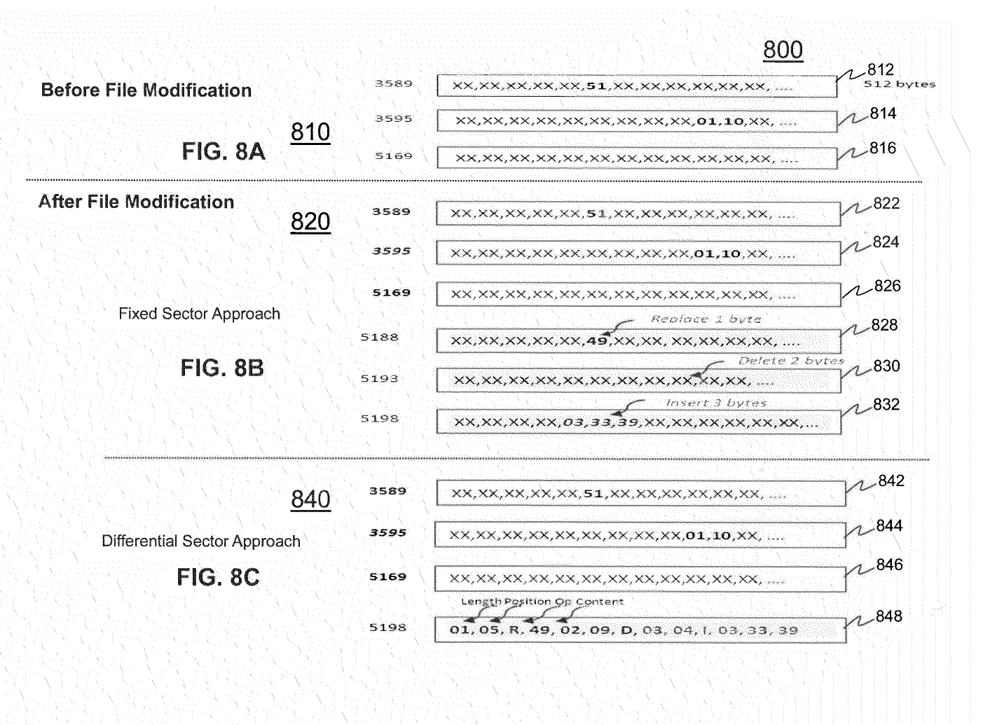

In a further illustration of the differential-sector approach, FIGS. 8A, 8B and 8C illustrate a side-by-side comparison of updates to a file using both a fixed-sector approach as well as the differential-sector approach, in accordance with an embodiment of the present invention. In FIG. 8A, three sectors are shown in the file system prior to any modification. In this example, each sector has a length of 512 bytes. Sectors 3589, 3595 and 5169 are shown, with the particular bytes of interest identified for the purposes of illustration. The file updating process wishes to make the following changes to these bytes of interest. In the first sector, sector 3589, one byte is replaced. As shown in FIG. 8A, this byte of interest had an original value of “51.” In updating this byte, the new value to be stored is “49,” and thus the replacement byte now has a value of “49.” In the second sector, sector 3595, two bytes are desired to be deleted. In the illustration, the bytes having values “10” and “01” are to be deleted. Finally, in the third sector, sector 5169, new data that requires three bytes is desired to be added in the updating process. In the illustration, these three added bytes added have values of “03,” “33” and “39” respectively.

As noted earlier, the fixed-sector updating process is inefficient since it does not take into account the amount of data change in the sectors that are the target of the updating process. Thus, whether a relatively small portion of the three sectors, or the entire content of the three sectors, is to be updated, three new sectors are used to store the updated data. Thus, as FIG. 8B illustrates, sectors 5188, 5193 and 5198 are the resulting destination sectors that contain the updated sectors of original sectors 3589, 3595 and 5169 respectively.

FIG. 8C illustrates how the same changes to the data content would be effected using the differential-sector approach, in accordance with an embodiment of the present invention. In place of the use of three additional new sectors, one sector is used to store descriptors of the change in the stored data. In the illustrated case, sector 5198 is used to store the descriptors, and four descriptors are used to describe each data modification. In the exemplary embodiment, the four descriptors include the fields of span, position, operation and content. Thus, as illustrated in FIG. 8C, the first four entries in sector 5198 are the four descriptors that describe the one-byte replacement in sector 3589. Thus, “01” is the span (i.e., one byte) of the modification, ‘05’ indicates that the modification is made at the fifth byte location in the sector, the operation is replacement (“R”), and the new content is “49” that replaces the original content of “51.”

With respect to the second modification, the descriptors for a 2-byte “deletion” modification are as follows. Here, there are three descriptors that include the following information: “02” is the span of the modification, “09” indicates that the update is made at the ninth byte location in that sector, and the operation is a deletion (“D”).

With respect to the third modification, the four descriptors for a 3-byte “insertion” modification are as follows. The first descriptor, “03,” is the span of the modification, the modification is made at the fourth byte location in that sector, the operation is an insertion (“I”), and the fourth descriptor comprises the three values inserted, namely “03,” “33,” and “39.”

To fully implement the differential-sector approach, according to an embodiment, an additional table (not shown) must be populated that links the changes described in the descriptors to the baseline sectors. Thus, for example, the changes recorded in sector 5198 must be linked to sectors 3589, 3595 and 5169 respectively.

Thus, as FIGS. 8A, 8B and 8C illustrate, the differential-sector approach is efficient since only the changes in the content of the file system are stored, rather than the storage of an entirely new sector for each sector undergoing modification.

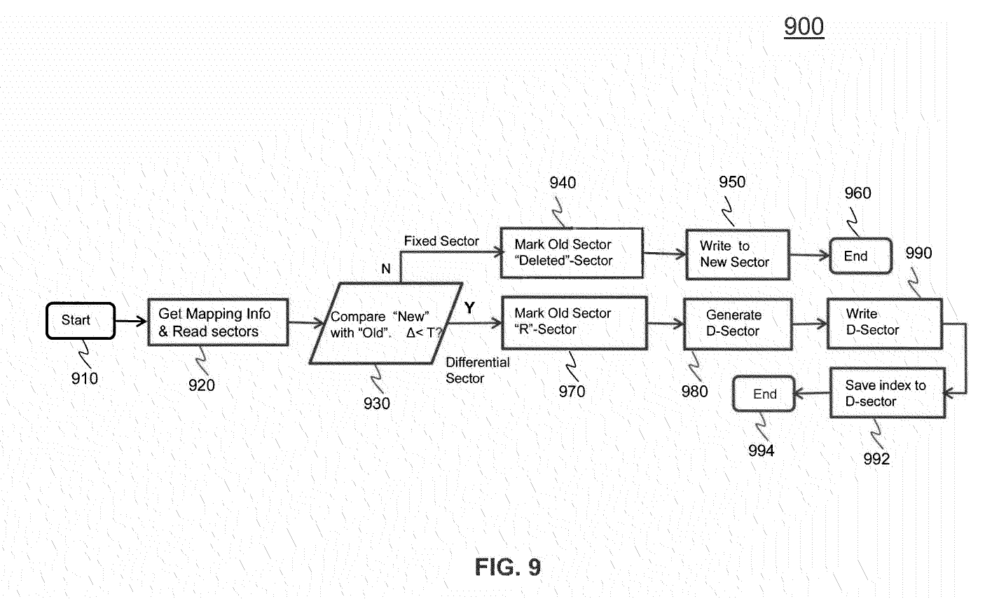

FIG. 9 provides a flowchart of a method that uses the differential-sector approach for a memory device, according to an embodiment of the present invention. The process begins at step 910.

In step 920, the first step in the write data request procedure is to obtain the mapping information as to where target of the write data request is stored. Having obtained the sector information, the relevant sectors are read to establish the current values stored in those sectors.

In step 930, the current sector content and the write request data are compared. If the comparison indicates that the amount of change in sector content between the current and the new sector is below a predetermined threshold, then the old sector is marked as an “R” or “referenced” sector in step 970.

In step 980, a D-sector (“differential” sector) is generated and in step 990 written with the descriptors comprising the differential information. In step 992, an index to the D-sector is saved to the mapping table to provide the appropriate association between the R-sector and the D-sector.

At step 994, method 900 ends.

Alternatively, if the comparison in step 930 indicates that the change in sector content between the current and the write request data is above or equal to a predetermined threshold, then the differential-sector approach is not followed. Instead a fixed-sector approach using steps 940 (mark old sector as a “deleted” sector) and 950 (write to new sector) is followed before the method ends at step 960. This comparison test, and the setting of the predetermined threshold, ensures that the overhead in administering the differential-sector approach is less than the benefit offered by the differential-sector approach. Thus, significant changes in the content of one or more sectors are more likely to be done with the fixed-sector approach while minor, but often more frequent, data content changes are best handled with the differential-sector approach. The overhead associated with the differential-sector approach also includes the step of reading a sector so that the differences the new data and the current sector data can be evaluated. However, the overhead of reading a sector is relatively minimal as the reading operation is a relatively fast operation.

The benefits of the differential-sector approach can be readily quantified. For example, a case study of data changes in a flash memory system provided the following statistics. On average, content change operations affect 3% of the sector content, and the sector operations involve 1 replacement, 1 deletion and 1 addition operation per sector. Based on the case study, a total of 512 bytes are written on average using the fixed-sector approach, while only 21 bytes are written using the differential-sector approach.

In additional to the immediate benefits of a reduction in the sector usage footprint, the differential-sector approach extends the lifetime of flash memory by reducing the amount of write operations, the absence of a need to erase old content and the reduction in the total number of erase times.

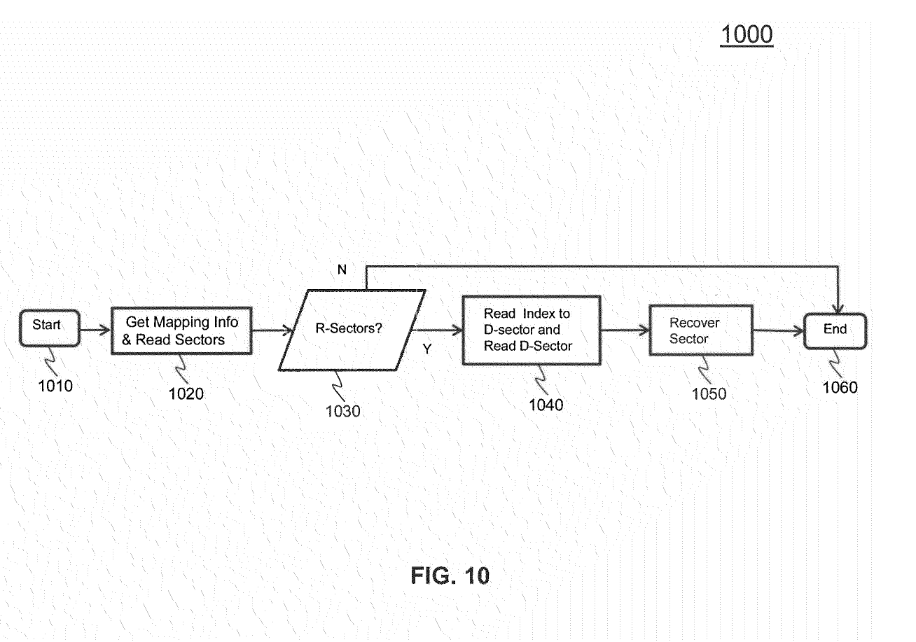

FIG. 10 provides a flowchart of a method that reads a sectorized memory device using the differential-sector approach, according to an embodiment of the present invention. The process begins at step 1010.

As with the write data request procedure illustrated previously in FIG. 9, step 1020 in the read data request procedure obtains the mapping information as to where the relevant data is stored. Having obtained the sector information, the relevant sectors are read to establish the current values stored using the following steps.

In step 1030, a determination is made whether there are any “R” sectors. If the determination indicates that there is an “R” sector, then in step 1040, the index in the mapping table to the “D” sector is read. In step 1050, the content of the sector is recovered from both the original “R” sector, together with the associated differential information in the “D” sector. If the sector is not tagged as an “R” sector, then no further action is required beyond the read of this sector.

At step 1060, method 1000 ends.

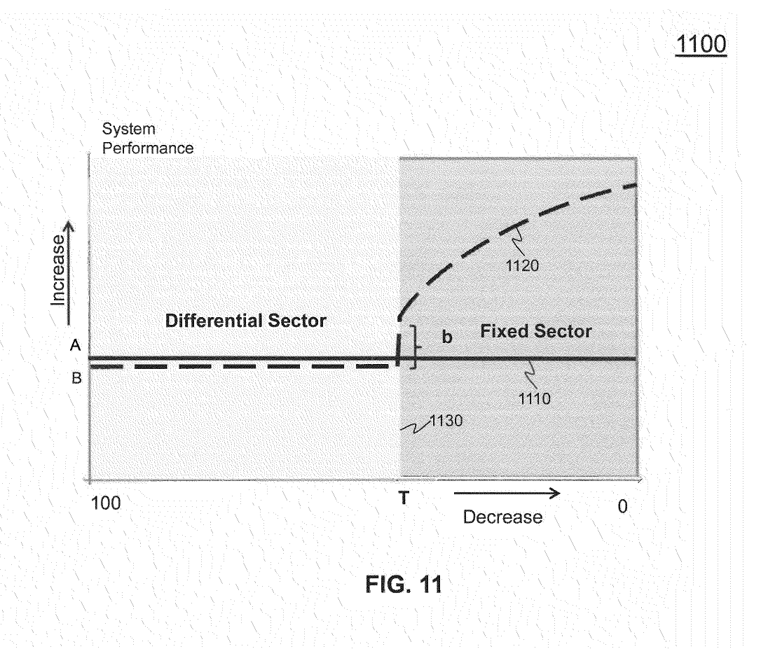

FIG. 11 illustrates the results of a simulation study to determine the impact of the value of the predetermined threshold used in the differential-sector approach, according to an embodiment of the present invention. As noted above with respect to FIG. 9, the predetermined threshold T (1130) is used to determine in any given situation whether the fixed-sector approach (1110) should be used, or a switch to the differential-sector approach (1120) should be made. Examining FIG. 11, the differential-sector approach (1110) offers a slight reduction in performance for large changes in the sector data, due to the overhead described above. However, as the amount of change in sector data reaches the predetermined threshold T, there is an improvement in performance. The size of that improvement (labeled as “b” in FIG. 11) depends on the choice of predetermined threshold T. Through a careful choice of the value of predetermined threshold T, one can ensure that the switchover is performed when the size of that improvement meets the desired level. Of course, for smaller changes in the sector data, the improvement continues to increase as the level of changes in sector data decrease.

In summary, various embodiments of the differential approach detect the similarity between the old and new sector contents, and write the differential or “delta” content to the sectorized memory device. In one embodiment, the differential content can be metadata that describes the differences between the new and the old sector contents. For example, metadata can include data that describes a sector position of a difference, a sector span affected by the difference, the operational type of the difference and the one or more data values associated with the difference. In a further embodiment, the differential content, either in metadata form or in another form, can be compressed by a suitable compression algorithm to further reduce usage of space in the sectorized memory device.

Persons of ordinary skill in the art would recognize that the differential-sector approach applies to not only sectorized memory devices, but to all memory devices whose memory access operations are limited to fixed length physical blocks and thereby sub-sector (sub-block) operations are not possible. Further, the differential-sector approach offers differences over other file system approaches, such as the JFFS2 (journaling flash file system version 2) approach. JFFS2 is a log-structured file system for use with flash memory devices. In response to data updates, JFFS2 simply writes all updates to data and metadata sequentially to a continuous stream, called a log. Thus, JFFS2 logs the full new content without performing any analysis of the correlation between the old and the new data contents. In contrast, the differential-sector approach detects the similarity between the old and new sector contents, and writes the “delta” content to the memory device.

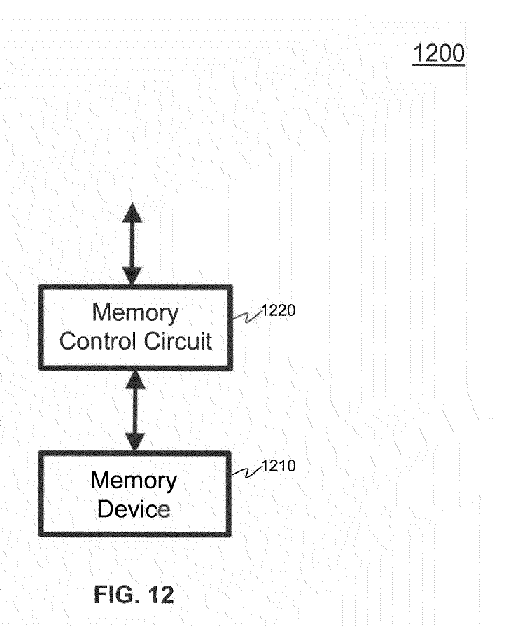

Further, persons of ordinary skill in the art would recognize that embodiments of the present invention are applicable to many types of memory devices and associated memory control circuitry, including but not limited to solid state drives (SSD), EMMC (embedded multi-media cards), ESATA (external serial advanced technology attachments), UFS (universal flash storage) devices and SDIO (serial digital input/output) devices. FIG. 12 illustrates a memory device 1210 and an associated memory control circuit 1220, in accordance with an embodiment of the present invention. Memory device 1210 may include any of the aforementioned memory devices. Memory control circuit 1220 may provide the access functionality for memory device 1210, in accordance with various features described above.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Some embodiments may be implemented in hardware, firmware, software, or any combination thereof. For example, modules in FIGS. 1 and 12 may be implemented as a computing device that can execute computer-executable instructions stored on a computer readable medium as follows. Some embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method, comprising:
receiving a write request for a sectorized memory device, wherein the write request is associated with one or more existing sectors in the sectorized memory device;
determining data differences based on comparing data of the write request with existing data in the one or more existing sectors; and
writing a differential sector based on the data differences.

2. The method of claim 1, further comprising:
marking, in a mapping table, at least one of the one or more existing sectors as an updated sector.

3. The method of claim 1, wherein the determining data differences includes identifying at least one of a position, a span, an operation type and one or more data values.

4. The method of claim 3, wherein the operation type includes a replacement operation, an insertion operation and a deletion operation.

5. The method of claim 1, wherein the sectorized memory device is a flash memory device.

6. The method of claim 1, further comprising:
updating a mapping table to tag at least one of the one or more existing sectors as an updated sector, and to associate the updated sector with the differential sector.

7. The method of claim 6, further comprising:
reading data from the sectorized memory device using the one or more updated sectors, the differential sector and the mapping table.

8. The method of claim 1, wherein the writing a differential sector based on the data differences includes writing a differential sector if an amount of the data differences is less than a predetermined threshold.

9. The method of claim 8, wherein the predetermined threshold is based on a predetermined improvement in efficiency of writing data to the sectorized memory device.

10. The method of claim 1, wherein the determining data differences includes reconstructing existing data based on an updated sector and an existing differential sector, the method further comprising:
tagging the existing differential sector as referenced.

11. The method of claim 1, wherein writing the differential sector based on the data differences includes writing metadata that describes the data differences.

12. The method of claim 1, further comprising:
compressing the differential sector using a compression algorithm.

13. An apparatus, comprising:
a sectorized memory device; and
a memory control circuit coupled to the sectorized memory device, the memory control circuit configured to:
receive a write request for a sectorized memory device, wherein the write request is associated with one or more existing sectors in the sectorized memory device;
determine data differences based on comparing data of the write request with existing data in the one or more existing sectors; and
write a differential sector based on the data differences.

14. The apparatus of claim 13, wherein the memory control circuit is further configured to:
mark, in a mapping table, at least one of the one or more existing sectors as an updated sector.

15. The apparatus of claim 13, wherein the memory control circuit is further configured to determine data differences by identifying at least one of a position, a span, an operation type and one or more data values.

16. The apparatus of claim 15, wherein the operation type includes a replacement operation, an insertion operation and a deletion operation.

17. The apparatus of claim 13, wherein the sectorized memory device is a flash memory device.

18. The apparatus of claim 13, wherein the memory control circuit is further configured to:
update a mapping table to tag at least one of the one or more existing sectors as an updated sector, and to associate the updated sector with the differential sector.

19. The apparatus of claim 18, wherein the memory control circuit is further configured to:
read data from the sectorized memory device using the one or more updated sectors, the differential sector and the mapping table.

20. The apparatus of claim 13, wherein the memory control circuit is further configured to write a differential sector based on the data differences by writing a differential sector if an amount of the data differences is less than a predetermined threshold.

21. The apparatus of claim 20, wherein the predetermined threshold is based on a predetermined improvement in efficiency of writing data to the sectorized memory device.

22. The apparatus of claim 13, wherein the memory control circuit is further configured to:
determine data differences by reconstructing existing data based on an updated sector and an existing differential sector; and
tag the existing differential sector as referenced.

23. The apparatus of claim 13, wherein the memory control circuit is further configured to write the differential sector based on the data differences by writing metadata that describes the data differences.

24. The apparatus of claim 13, wherein the memory control circuit is further configured to:
compress the differential sector using a compression algorithm.
